(19) United States
(12) Patent Application Publication
(10) Pub. No.: US 2012/0077153 A1
(43) Pub. Date: Mar. 29, 2012

(54) NUTRITION-CONTROL DEVICE

(76) Inventor: Orly Livny, Ramat Gan (IL)

(21) Appl. No.: 12/890,858

(22) Filed: Sep. 27, 2010

(51) Int. Cl. G09B 19/00

(52) U.S. Cl. 434/127

(57) ABSTRACT

The invention provides a nutrition-control device and method for a continuous follow-up of the daily consumption during a prophylactic or therapeutic diet, enabling the active participation of a dieter in selecting the menu, and stimulating the dieter's motivation.

### FIELD OF THE INVENTION

The invention relates to a nutrition-control method and a nutrition-control device for a continuous follow-up of the daily consumption during a diet with a predetermined daily calorie or nutrient intake.

### BACKGROUND OF THE INVENTION

About two thirds of adults in the United States are overweight, and roughly one third are obese, when characterized by body mass index according to NIH [see, e.g., Flegal K. M. et al.: J. Am. Med. Assoc. 288 (2002) 1723-7]. Health problems associated with a high proportion of body fat, including cardiovascular diseases, diabetes, arthritis, sleep disorders, and some forms of cancer, are known, as well as the problems associated with attempts to reduce said body fat. Deaths attributable to bad dietary habits are estimated as high as 300,000 in the US each year, and economic costs related to overweight are greater than $100 billion. Health considerations and social pressures keep many people in never-ending efforts to reduce their weight. Americans spend more than $30 billion annually on weight-loss products and services. Among the means for weight control, which include exercise, diets, drugs, and surgeries, dieting is most frequently employed.

Hundreds of types of diets can be found, regulating the composition and caloric content of allowed daily portions. However, more than the diet type, the factors that decide the diet success rather comprise strong motivation, careful adherence to the fixed rules, and long-term continuation. A successful diet needs a careful follow-up, and numerous organizers have been provided to assist a dieter in keeping the fixed rules. U.S. Pat. No. 4,606,555 provides a diet control device and method, comprising a readymade booklet in which each page represents one day in the plan, the page comprises a plurality of detachable tabs on which various food sub-portions are described, wherein all tabs on one page total the fixed daily portion. The tabs are detached during the day as the food sub-portions are consumed, enabling to see how many food items remain to be consumed till the end of the day. U.S. Pat. No. 5,338,202 provides a daily diet management planner and method, comprising a case having six meal pockets, each representing one daily meal such as breakfast or dinner, and a plurality of cards grouped separately in storage pockets of said case according to the food type, each representing a food portion. Every day, the dieter selects cards totaling the fixed daily portion, and transfers them from the storage pockets to the meal pockets according to her/his taste. U.S. Pat. No. 5,381,165 provides a calorie counter device and method, comprising an abacus-like counter, wherein the beads correspond to various food items, and are moved as the items are consumed. U.S. Pat. No. 5,412,564 provides a system and method for diet control, comprising a computerized monitoring system for maintaining a real time record of a consumer, who inserts a personalized smart card into card reader before a purchase transaction at a store. US 2002/0015723 provides a diabetic diet management system, comprising exchange cards belonging to several food groups, a list of daily meals and the number of cards of various food groups for every meal—the cards totaling the fixed daily intake in accordance with a fixed diet type. The cards are moved to another location as the corresponding items are consumed, without dieter's active participation in planning the diet. U.S. Pat. No. 4,310,316 provides a diet control apparatus which, however, also excludes dieter's active participation in planning the diet. U.S. Pat. No. 4,979,901 provides a complex planning means for a dieter, comprising calculations. The follow-up system should be simple, it should enable quick assessment of the daily portion still not consumed, it should not demand complex calculations but should enable dieter's active involvement in the follow-up process and in the menu selection. The existing systems are either too complicated, or do not give the dieter any feeling of freedom of action. It is therefore an object of this invention to provide a nutrition-control device for planning and follow-up of daily calorie intake, which would enable dieter's active participation and be simple enough to be used by any person in need of such diet, including children.

There are numerous conditions, beside high body fat, requiring a nutrition control. Diabetic diet intends to adjust caloric and carbohydrate intake to the available amounts of insulin or diabetic drugs; gout diet minimizes the intake of purine bases; high-fiber diet decreases transit time of food in the bowel and is used during the treatment of some colon disorders, but it may also assist in handling hyperlipidemia, etc.; low residue diet minimizes functional stress on the colon; low salt diet accompanies the treatment of syndromes characterized by fluid retention; low-fat diet, comprising minimal amounts of fat and cholesterol, should reduce the risk of heart diseases; elimination diet may help in finding allergy causes; high-calorie diet may be required to restore body weight in eating disorders or in convalescence; etc. There are other diets, created for rare disorders, or for special situations, in which certain food components must be controlled, wherein the control may comprise decreasing the intake of a component, for example in case of a sensitivity, or the control may comprise increasing the intake of a component, for example in case of hypovitaminosis, or the control may comprise adjusting ratio of the components, for example in diets for active sportsmen.

A balanced diet should provide all essential nutrients with a reasonable ration of all the major food groups [Stedman's Medical Dictionary, 26^{th} Ed. Williams & Wilkins, 1995]. For the sake of simplicity, the term “nutrient” will be used hereinafter for a food component, or a group of components, comprising certain chemical composition, its caloric value notwithstanding. Thus, the word nutrient will comprise such terms as “proteins or fats”, as well as “vitamins or elements”.

Beside therapeutic diets, or therapy-accompanying diets (used, e.g., in cases of gastrointestinal disorders, metabolic disorders, renal failure, cystic fibrosis, hypersensitivity disorders, diabetes, etc.), there are also prophylactic diets. It turns out that adjusting ratios of some nutrients in the food may have prophylactic effects in regard to some ailments. For example, the risk of coronary artery disease might be affected by lowering the fat intake. The average U.S. diet contains 37% of total calories as fat. The American Heart Association recommends that the proportion be reduced to 30% [The Merck Manual of Diagnosis and Therapy, 17^{th} Ed., 1999].

It is therefore also an object of this invention to provide a nutrition-control device for planning and follow-up of any daily diet in purpose to maintain a balanced diet based on healthy correct nutrition, which device would enable dieter's active participation, and would be simple enough to be used routinely by any person, including children.

It is another object of this invention to provide a nutrition-control device and method enabling a safe diet on the daily base, without any health risks even for school children, and easily controllable by their parents.

It is still another object of this invention to provide a nutrition-control device and method enabling the dieter to be actively involved in the choice/preparation of the final diet menu, even if the principles of the diet are decided by a physician or a dietary professional.

It is a further object of this invention to provide a nutrition-control device and method enabling the dieter to see at any moment the food items still allowed for consumption that day.

It is a still further object of this invention to provide a nutrition-control device and method making the diet follow-up interesting for children and adults.

It is also an object of this invention to provide a nutrition-control device and method which may be easily employed even during outdoor activities, during traveling, and over long-term periods.

It is also another object of this invention to provide a nutrition-control device which is stable, portable, and easy to manage.

It is an aim of the invention to provide a nutrition-control device and method which resemble a shopping game, in which each food item may be consumed only after being paid for by “food-money”, wherein the sum of “food money” available each morning to the dieter is determined according to the diet requirements.

It is further an aim of the invention to provide a nutrition-control device and method, comprising food-money to be “exchanged” during the day for food items, wherein said food-money may be either physical or virtual, contained, for example, in a wallet or in a personal electronic device.

Other objects and advantages of present invention will appear as description proceeds.

### SUMMARY OF THE INVENTION

The present invention provides a nutrition-control method for a continuous follow-up of the daily consumption during a diet with a predetermined daily energy/nutrient intake, comprising i) providing a plurality of exchange entities (food-notes), each being allotted a certain energy/nutrient equivalent (exchange-value), such as kcal-equivalent or gram-equivalent or unit-equivalent, and each food-note being allotted a list of food items (items-list), wherein each item has an energy content or a nutrient content equal to said exchange-value; ii) selecting daily a group of food-notes (“daily-wad”) whose sum of exchange values essentially equals said predetermined daily intake, and moving them from their storage site (“store-room site”) to an exposed site (“oven-site”) to be easily viewed; iii) using the selected food-notes during the day as permission tickets and as game money, wherein only such food item, characterized by its kind and size, may be consumed that is on an items-list of at least one food-note of said daily-wad, and wherein each item on the list can replace any other food item recited on the same list during the consumption, and iv) always after consuming a food item, removing at least one food-note having in its items-list the consumed item from said oven-site back to said store-room site; thereby continuously visualizing the food items still allowed for the consumption that day. Said food-note in the method according to the invention contains data comprising an exchange-value, an items-list, a food type, and optionally further recommendations and information related to special diets or food items. In a preferred embodiment of the invention, said food-notes differ in colors according to the food type of the items they comprise. In one aspect of the invention, said food-note is a physical object, such as a paper or plastic card. In one embodiment of the method, said oven-site is represented by a group of bags or pockets, possibly transparent, bound together, into which food-notes are inserted. In another aspect of the invention, said food-note is a data sheet or a data set in an electronic device, and said oven-site is represented by a part of memory comprising the data corresponding to the selected food-notes, and may be representable as a plurality of cards arranged on one screen. The method according to the invention comprises selecting, repeatedly on the daily base, a group of food-notes representing food items allowed for the consumption, and further gradually removing the food-notes from the selected group as the allowed servings are consumed during the day.

The invention is directed to a nutrition-control device for a continuous follow-up of the daily consumption during a diet with a predetermined daily energy/nutrition intake, comprising i) a plurality of exchange entities (food-notes), each being allotted a certain energy/nutrition equivalent (exchange-value, such as kcal exchange value), and each being allotted a list of food items (items-list), each item having the energy/nutrition value equal to said exchange-value, said food-notes being used as game money to be exchanged for food-items during the daily consumption; ii) a site for locating food-notes to be exchanged during the day for food items, said site (oven-site) enabling an easy assessment of the amount of food still allowed for the consumption that day; and optionally iii) a site for storing food-notes (store-room site) that are not in the oven-site. Said food-notes in the nutrition-control device according to the invention are preferably divided to several groups according to the type of food items, and comprise data consisting of kcal exchange-values, items-list, and optionally recommendations and information related to the diet. In one aspect, said food-note is a physical item to be moved from the oven-site to the store-room site after consuming a food-item. The device may be a wallet having a plurality of pockets or bags, e.g. at least partially transparent, for inserting paper or plastic food-notes. Said transparent pockets or bags enable to view as many food-notes as possible simultaneously, providing an easy assessment of the remaining food-notes. The device may comprise a stable outer cover, and at least partially transparent pockets arranged as pages in said wallet, as the oven-site. The food-notes may be represented by cards, divided into several six groups differing by the type of food and differently colored, each having a distinctly printed exchange value, and an items-list comprising various servings that may be consumed. The device may comprise a non-transparent pocket as a store-room site for the food-notes that are not used today or for the food-notes removed from the oven-site today. The device may be an electronic organizer, displaying images of food-notes on the screen, being programmed to comprise virtual food-notes in form of data sheets, created as cards, each card comprising an exchange value and an items-list, together with the information related to the type of food, and eventually other useful information. The sheets corresponding to different types of food may be graphically distinguished from each other. The device may comprise two memory sites, one for locating the food-notes selected for the daily consumption, another one for storing all the remaining food-notes, wherein after inputting into the device the fact of consuming a food serving, the corresponding food-note disappears from a virtual oven-site and appears in a virtual store-room site. The used food-note preferably changes its graphical appearance. The food-notes corresponding to the daily-wad may be arranged in a data sheet presentable on one screen, so that food-notes gradually either disappear or change color, as food items are consumed. In another aspect of the invention, the device may combine a physical wallet or booklet with an electronic organizer.

The invention provides a nutrition-control device for use as a means enabling any person to manage a therapy-accompanying diet. The invention also provides a nutrition-control device for use as a means enabling any person, including a healthy person, to manage a correct, balanced, and healthy diet on the daily base.

### BRIEF DESCRIPTION OF THE DRAWINGS

The above and other characteristics and advantages of the invention will be more readily apparent through the following examples, and with reference to the appended drawings, wherein:

FIG. 1 shows a wallet for food-notes in one embodiment of the invention.

### DETAILED DESCRIPTION OF THE INVENTION

Being aware that regulating daily calorie intake may be a task not less difficult than dealing with drug addiction, which task requires the use of both physical and psychological means, we have developed a method stimulating the dieter's interest and motivation, and enabling her/his active involvement. The method comprises using food-notes, wherein a food-note is an exchange entity being equivalent to a certain number of kilocalories (kcal), wherein said entity may be either a physical item, such as a small card with a printed kcal exchange-value, or a virtual item, such as a data set on a data sheet in a personal electronic organizer, which data set comprises a kcal exchange-value. Each food-note, beside the kcal exchange-value, further comprises a list of food items (“items-list”), each of the items having a nutrition caloric content approximately equal to said kcal exchange-value. The method of the invention comprises the steps of first determining the necessary daily kcal intake, preferably together with a physician or other health professional; and then repeatedly, on daily base, selecting a group of food-notes (“daily-wad”) whose kcal equivalents approximately add up to said daily kcal intake; using the selected food-notes during the day as game money, wherein only such food item may be consumed that is in an items-list on a certain food-note of said daily-wad; and finally removing said certain food-note from said daily-wad. Said daily-wad should be approximately equivalent to the daily caloric intake or might be lower, but preferably as close to the daily intake as enabled by the existing exchange-values. In the method of the invention, the daily-wad is prepared daily and spent daily.

Of course, the method is applicable for any type of diet, whether the energy uptake is controlled, or a nutrient uptake is controlled, wherein said nutrient may be, for example, a fat or cholesterol, proteins or amino acids, starch or sugars, vitamins or a vitamin, elements, sodium chloride, gluten, purine bases, saturated fats, other metabolically important combination of chemicals, etc. The method is preferably used as a means enabling any person to manage a scientifically correct, balanced, and healthy diet on the daily base. The present invention thus provides a nutrition-control method for a continuous follow-up of the daily consumption during a diet with a predetermined daily energy/nutrient intake, comprising i) providing a plurality of exchange entities (food-notes), each being allotted a certain energy/nutrient equivalent (exchange-value), and each food-note being allotted a list of food items (items-list) whose energy or nutrient content equals said exchange-value; ii) selecting daily a group of food-notes (daily-wad) whose sum of exchange values is approximately equal to said predetermined daily intake, and moving them from their storage site (store-room site) to an exposed site (oven-site) to be easily viewed; iii) using the selected food-notes during the day as permission tickets and as game money, wherein only such food item, characterized by its kind and size, may be consumed that is on an items-list of at least one food-note of said daily-wad, and wherein each item of said list can replace any other item from viewpoint of energy or nutrient intake, and iv) always after consuming a food item, removing one food-note having in its items-list the consumed item from said oven-site back to said store-room site; thereby continuously visualizing the food items still allowed for the consumption that day. Said food-note in the method according to the invention contains data comprising an exchange-value, an items-list, a food type, and optionally further recommendations and information related to special diets or food items. Said diet with a predetermined daily energy/nutrient intake may be a weight-reducing diet, fat-controlling diet, low-carbohydrate diet, etc. Said predetermined daily energy/nutrient intake may be a maximal value for daily calorie intake or daily nutrient intake based on scientific knowledge, or recommended by a diet professional. Said energy/nutrient equivalent may be, for example, kcal equivalent. The energy/nutrient equivalent essentially relates to a certain quantity defined as one portion of the group-food. The units of said exchange-value may comprise kcal, gram, mg, international unit, etc.

Wherever the term nutrient is used herein, a food component, or a group of components, is intended that is relevant in regard to certain metabolic aspect, or to treating or preventing certain health problem. The term diet is used, in accordance with the context, for daily consumed food portion which is controlled by rules restricting its caloric value or nutrient composition, or for daily consumed food portion, preferably complying with the requirements of healthy nutrition.

The invention provides a method for follow-up of the daily food and drink consumption with the dieter's active participation, for example, in cases of calorie intake restriction, wherein the dieter chooses everyday her/his favorite meals/servings from a pre-created, rich list of possibilities, by selecting said food-notes to make up the required total calorie sum. It is important, especially in long-term diets, to balance the nutrients in optimal ratios. In a preferred embodiment of the invention, the method enables the follow-up of the daily consumption while ensuring the balanced diet, which may include also a diet without any nutritional limitations. It is achieved by dividing the food-notes into the groups according to the type of food, each group being distinctly marked (e.g., by color), enabling to easily select a daily-wad with both the required calorie sum and the required composition. Simply, every morning, the dieter has got a number of servings of every important nutrition type that represent her/his daily budget.

In one aspect of the invention, said food-note is a physical object, such as a paper or plastic card. In one embodiment of the method, said oven-site is represented by a group of bags or pockets, possibly transparent, or otherwise enabling to review their content, bound together, into which food-notes are inserted. In another aspect of the invention, said food-note is a data sheet or data set in an electronic device, and said oven-site is represented by a part of memory comprising the data corresponding to the selected food-notes, and representable as a plurality of cards arranged on one screen. The method according to the invention comprises selecting, repeatedly on the daily base, a group of food-notes representing food items allowed for the consumption, and further gradually removing the food-notes from the selected group as the allowed servings are consumed during the day.

The invention is further directed to a nutrition-control device comprising a plurality of food-notes, wherein each food-note is an entity comprising a set of data, which data consist at least of an energy/nutrient (e.g. kcal) exchange-value and a list of food items, each item having the energy/nutrition content equal to the exchange-value of its food-note. Said nutrition-control device further comprises “oven site” for storing food-notes selected for food items to be eaten today, and “food-store site” for storing all other food-notes. The two sites may be physical spaces in a physical device, such as two pockets in a small plastic or leather wallet, or they may represent data locations in an electronic device. When preparing a daily menu, the dieter transfers food-notes from the “food-store site” to the oven-site, and when consuming a food item, the dieter transfers the corresponding food-note from the “oven-site” to the “food-store site”. The oven-site is preferably divided to more sub-sites (“shelves”) in which the food-notes may be easily reviewed, the shelves being, for example, represented by a plurality of transparent pockets in a physical wallet, or by a display of food-notes on the screen of a pocket electronic personal organizer. Preferably, food-notes corresponding to different food-types (e.g., having different colors) are stored separately (placed on different shelves).

In a preferred embodiment of the invention, the diet is a low-calorie diet, and the food-notes are colorful cards divided to several groups, for example six groups, according to the type of food, each group having different color, for example, cereal and bakery items being yellow, fat items violet, etc., each card having a distinctly printed kcal exchange-value, and containing a list of food servings of which nutrition value is approximately equal to said exchange-value, such as “1 apple” and “3 plums”, etc. The card may further include information related to the type of food, type of diet, recommendations, etc. Of course, different sets of cards are used for different diet types. Food-notes for low-cholesterol diet, preferably created by a diet specialist, will contain, for example, servings comprising olive oil, sea plankton, tuna and salmon, canola oil, etc. The cards for a diabetes diet will have again different items-lists, and possibly different number of groups as well.

Determining the daily energy/nutrients intake is preferably performed by, or together with, a physician or a diet expert. In a preferred embodiment of the invention, the dieter selects, in accordance with the predetermined daily quantities of calories and/or nutrients, a daily-wad in the morning, or in the evening for the next day. The dieter includes her/his favorite food items, the selection of the items may occur either in advance or during the meal time. The dieter will be aware of the fact that food diversity is usually desired, and in a preferred embodiment, said diversity will be indicated by the presence of many colors in the daily-wad. Food-notes of the daily-wad will be preferable arranged in such a way that as many food-notes as possible will be visible simultaneously, enabling a simple assessment of the food-notes remaining in the oven-site. Food-notes corresponding to different types of food will be preferably stored together. Said predetermined type of diet may take into account special requirements of the dieter, her/his age, disorders, etc. In some cases, the daily intake will be divided to several meals, and the food-note corresponding to those meals will be placed separately in the shelves of the oven-site. Before a serving is consumed, the dieter should find a corresponding food-note, and, closely before or after consuming it, remove it from the oven-site. Only such a serving that appears on the items-list of at least one food-note in the oven-site may be consumed, and no other, wherein each item of said list can replace any other item from the viewpoint of the energy or nutrient intake.

The eaten serving is “paid for” by a food-note, which is moved from the oven-site to a store-room site. The store-room may be divided into divisions, e.g., according to the type of food, having food-notes of the same color packed together. As the day passes on, the daily-wad gets thinner, and the number of food-notes decreases. The food-note are preferably stored in such a way that the type and number of remaining food-notes is easily seen.

In one preferred arrangement of the invention, the nutrition-control device comprises a wallet that can be easily inserted into a pocket, for example having the shape of a booklet about 10 cm high and about 2 cm thick, provided with a stable outer cover, such as made of leather or plastic, preferably nicely decorated, said device further comprising at least partially transparent pockets arranged as pages in said wallet. Said device further preferably comprises a set of color cards on which calorie exchange values and items-lists are printed, said items-lists comprising various servings that may be principally consumed. The pockets should be easily movable as pages in a booklet, and may comprise a polymer material or other material that is translucent or transparent, so that at least the color of food-notes is discernible, and preferably at least part of the pocket being transparent, so that the data on food-note are readable. The device further comprises a store-room site for storing the “used” food-notes, i.e. the food-notes removed from the oven-site, the site being, for example a non-transparent pocket. In one embodiment, only the daily-wad is carried in the wallet during the day, in another embodiment, all existing food-notes are contained in the wallet.

In another preferred arrangement of the invention, the nutrition-control device comprises an electronic memory device, such as a personal organizer, being easily portable, e.g., in a pocket of the clothing, and being programmed to comprise virtual food-notes in form of data sheets, created as cards, each card comprising a calorie exchange value and an items-list, together with the information related to the type of food, and eventually other useful information. The data sheets corresponding different types of food may be graphically distinguished from each other. The electronic device may comprise two memory sites, one for the food-notes selected for the daily consumption, another one for storing all the remaining food-notes. When consuming a food serving, the corresponding food-note may disappear from a virtual oven-site and appear in a virtual store-room site. Alternatively, the used food-note may distinctly change its graphical appearance, for example turning dark, etc. In one possible representation of the daily-wad, the cards corresponding to the food-notes are all arranged on one screen, and gradually either disappear or change color. Of course, that a physical wallet may be combined with a thin electronic personal organizer.

In a further aspect, the invention enables everybody, including school children, organize the daily diet in accordance with prefixed rules, taking into account all special requirements. All possible servings form the contents of the items-lists on all food-notes, and may be represented by a plurality of real or imaginary cards. Preferably the cards comprise several color groups according to the types of food, and the cards in each color group are preferably identical. In order to make an items-list as broad as possible, in case of physical cards, said items-list is printed on both sides of said cards. In case of electronic organizer, there are no space problems. In one aspect of the invention, the dieter, including children and adults, learns by continuous use of the food-notes the caloric values and the nutrition composition recommended for her/his condition.

More generally, dieting represents a model situation in which a self-restraint is required. The method of the invention assists in a situation when the self-restraint is required, serving both children and adults. Another pedagogic aspect of the method of the invention is in teaching dieters the basics of healthy nutrition, including the caloric values and food types.

The servings may be described in an illustrative way, especially for children. For example, the serving size and kind on the food-notes may be accompanied by pictures, more or less schematic, such as picture of an apple or of ½ apple, etc.

### Example

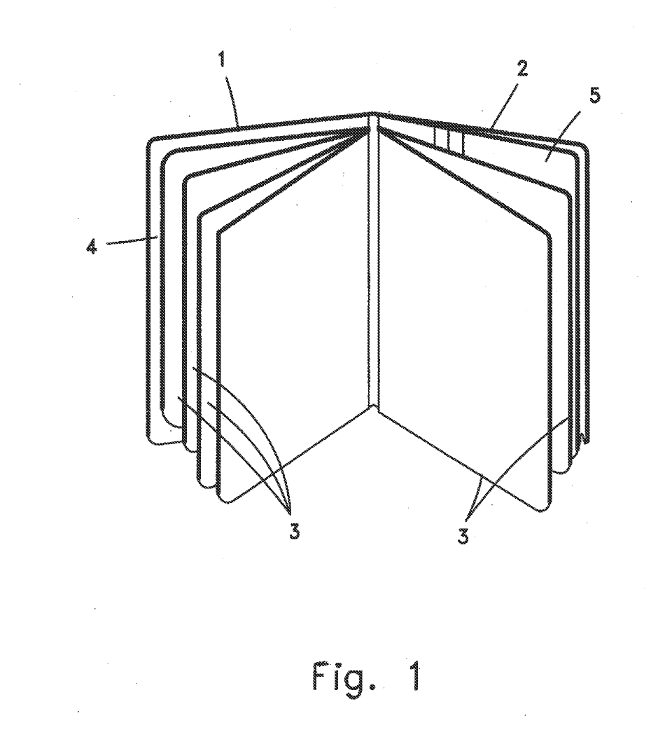

FIG. 1 illustrates an embodiment of a device according to the invention. The device is a wallet comprising a left part of the outer cover (1), and a right part of the outer cover (2), pages (3), wherein each page is a bag or pocket for inserting paper cards. Both parts of said outer cover serve for creating pockets (4) and (5) on their inner side. Pages (3) serve as the oven-site of the device, at least one of the pockets serves as the store-room site of the device. The oven-site is filled with food-notes, every morning before the first meal is consumed, the sum of kcal exchange-values of the food-notes in the bags should equal the daily intake prefixed for the employed diet regimen. Preferably each bag will contain several identical cards. The daily intake is preferably divided into as many servings as possible and practical. After consuming a serving, e.g. 1 apple, a food-note comprising 1 apple, is removed from the oven-site (3) and transferred to the pocket (5). The device may comprise further instructions, possibly inserted in pocket (4). As more servings are consumed, the “oven-sites” empties, and a quick view into the device shows how much may still be consumed. The page-bags or page-pockets may have openings near the inner edges of the pages, or near the upper edges, affecting the direction in which the food-notes are thrust into the bags or pockets (i.e. the food-notes are inserted to the bags or pockets from the open edge in a way that provides comfortable reading upon opening the device).

The device may comprise, e.g., 30 cards in 6 color groups. The dieter, having e.g. a low calorie diet of 1200 kcal/day, selects every day her/his daily-wad from said 22 cards. The selection may comprise, for example, 5 yellow (cereal and bakery, 70 kcal) cards, 2 violet (fat, 70 kcal) cards, 5 red (proteins, 85 kcal) cards, 6 green (vegetable, 20 kcal) cards, 3 ochre (fruit, 40 kcal) cards, and 1 blue (sweets, 40 kcal) cards, making 1200 kcal. Since the items-lists comprise more than 20 items each, there are many possible combinations of different food compositions, and the dieter will feel as an active participant in the decision making, and not as a passive object of a treatment.

While this invention has been described in terms of some specific examples, many modifications and variations are possible. It is therefore understood that within the scope of the appended claims, the invention may be realized otherwise than as specifically described.

1. A nutrition-control device for a continuous follow-up of the daily consumption during a diet with a predetermined daily energy/nutrient intake, enabling the active participation of a dieter in selecting the final menu, and stimulating the dieter's motivation, comprising
i) a plurality of exchange entities (food-notes), each being allotted a certain energy/nutrition equivalent (exchange-value), and each entity being allotted a list of food items (items-list), each item having the energy/nutrition content equal to said exchange-value, said food-notes being used as “game money” to be exchanged for food-items during the daily consumption;
ii) a site for locating food-notes to be exchanged during the day for food items, said site (oven-site) visualizing the remaining amount of food allowed for the consumption that day, said food-notes (daily-wad) having a sum of the exchange values essentially equal to a predetermined daily intake at the beginning of the day, said sum being determined by a health professional but items being freely selected from each list of items by the dieter; and
iii) a site for storing, and essentially hiding, food-notes (store-room site) that are not in the oven-site;
for use in treating or preventing a disorder necessitating a diet with a predetermined daily energy/nutrient intake, the conditions selected from obesity, gastrointestinal disorders, metabolic disorders, hepatic disorders, renal failure, cardiovascular disorders, musculoskeletal disorders, cystic fibrosis, hypersensitivity disorders, and diabetes.

2. A nutrition-control device according to claim 1, enabling a continuous follow-up of the daily consumption for a diet with a predetermined daily energy/nutrient intake, wherein only such food item may be consumed that is on an items-list of at least one food-note of said daily-wad, and wherein each item on an item-list may replace any other item in the same list during the consumption; and wherein always after consuming a food item, one food-note having in its items-list the consumed item is moved from said oven-site to said store-room site.

3. A device according to claim 1, wherein said food-note contains data comprising an exchange-value, an items-list, a food type, and optionally further recommendations and information related to special diets or food items.

4. A device according to claim 1, wherein said food-notes differ in colors according to the food type of the items they comprise.

5. A device according to claim 4, wherein said food type is selected from the group consisting of starch, fat, protein, vegetable, fruit, sweets, and carbohydrates.

6. A device according to claim 1, wherein said food-note is a physical object, such as a paper card.

7. A device according to claim 1, wherein said food-note is a data set in an electronic device.

8. A device according to claim 1, wherein said oven-site is represented by a group of bags or pockets, bound together, into which food-notes are inserted.

9. A device according to claim 1, wherein said daily-wad is selected repeatedly on the daily base, while removing the food-notes from said selected group as the allowed servings are consumed during the day.

10. A device according to claim 1, wherein said diet is a weight-reducing diet with a predetermined restricted daily calorie intake or a diet with controlled intake of at least one nutrient.

11. A device according to claim 10, wherein said diet is a therapy-accompanying diet or a prophylactic diet.

12. A device according to claim 10, wherein said diet is a balanced diet.

13. A device according to claim 11, wherein said prophylactic diet reduces the risk of coronary artery disease.

14. A nutrition-control device according to claim 1, wherein said food-notes are divided to several groups according to the type of food items they comprise.

15. A nutrition-control device according to claim 1, wherein said exchange-values are kcal exchange-values, and wherein said items-list comprises servings described by the type and quantity of food items.

16. A nutrition-control device according to claim 1, wherein said device is a wallet having a plurality of pockets or bags for inserting paper or plastic food-notes.

17. A nutrition-control device according to claim 1, wherein said device is an electronic organizer, displaying images of food-notes on the screen.

18. A nutrition-control device according to claim 16, wherein said pockets or bags enable to view as many food-notes as possible simultaneously, providing an easy assessment of the remaining food-notes.

19. A nutrition-control device according to claim 16, comprising a stable outer cover, and pockets arranged as pages in said wallet to serve as said oven-site, wherein said pockets are at least partially transparent or otherwise adjusted so as to enable an easy review of their content.

20. A nutrition-control device according to claim 16, further comprising a non-transparent pocket as a store-room site, for non-used food-notes or for the food-notes removed from the oven-site.

21. A nutrition-control device according to claim 17, being programmed to comprise virtual food-notes in form of data sheets, created as cards, each card comprising a calorie exchange value and an items-list, together with the information related to the type of food, and eventually other useful information.

22. A nutrition-control device according to claim 17, comprising two memory sites, one for locating the food-notes selected for the daily consumption, another one for storing all the remaining food-notes, wherein after entering into the device the fact of consuming a food serving, the corresponding food-note disappears from a virtual oven-site and appears in a virtual store-room site.

23. A nutrition-control device according to claim 17, wherein the food-notes corresponding to the daily-wad are arranged on one screen, and gradually either disappear or change color, as food items are consumed.

24. A nutrition-control device according to claim 1, combining a physical wallet or booklet with an electronic organizer.
